(19) United States
(12) Patent Application Publication
(10) Pub. No.: US 2026/0148527 A1
(43) Pub. Date: May 28, 2026

(54) DATA ANALYSIS DEVICE, DATA ANALYSIS METHOD, AND PROGRAM

(71) Applicant: Panasonic Intellectual Property Management Co., Ltd., Osaka (JP)

(72) Inventors: YIRAN JIANG, Osaka (JP); YUICHIRO SADANAGA, Osaka (JP)

(21) Appl. No.: 19/453,324

(22) Filed: Jan. 20, 2026

Related U.S. Application Data
(63) Continuation of application No. PCT/JP2024/018690, filed on May 21, 2024.

(30) Foreign Application Priority Data
Jul. 25, 2023 (JP) 2023-121010

(51) Int. Cl. G06V 10/77; G06N 3/0464; G06T 7/00; G06V 10/75; G06V 10/82

(52) U.S. Cl. CPC G06V 10/7715; G06N 3/0464; G06T 7/0002; G06V 10/758; G06V 10/82; G06T 2207/30168

(57) ABSTRACT

Data analysis device (1) includes acquisition unit (110) configured to acquire target data that is unstructured data related to a product and quality information indicating the acceptability of the product, feature vector extraction unit (140) configured to input the target data to each of a plurality of neural network models for analyzing unstructured data, extract a plurality of feature maps calculated by a plurality of intermediate layers included in each of the plurality of neural network models, and generate a quality map indicating the acceptability of the product represented in the unstructured data using the plurality of extracted feature maps, and integration unit (150) configured to generate an integrated map by applying statistical processing to a plurality of quality maps including the quality map.

### TECHNICAL FIELD

The present disclosure relates to a data analysis device, a data analysis method, and a program.

### BACKGROUND ART

A welding system capable of improving prediction accuracy of welding quality using machine learning is known (see PTL 1).

### Citation List

### Patent Literature

PTL 1: Unexamined Japanese Patent Publication No. 2022-65758

### Non-Patent Literature

NPL 1: Hideki Nakayama, “Image Feature Extraction and Transfer Learning by Deep Convolutional Neural Network”, [online], [searched on Jul. 10, 2023], Internet <URL: http://www.nlab.ci.i.u-tokyo.ac.jp/pdf/CNN_survey.pdf>

### SUMMARY OF THE INVENTION

A data analysis device according to an aspect of the present disclosure includes an acquisition unit configured to acquire target data that is unstructured data related to a product and quality information indicating the acceptability of the product, an extraction unit configured to input the target data to each of a plurality of neural network models for analyzing unstructured data, extract a plurality of feature maps calculated by a plurality of intermediate layers included in each of the plurality of neural network models, and generate a quality map indicating the acceptability of the product represented in the unstructured data using the plurality of extracted feature maps, and an integration unit configured to generate an integrated map by applying statistical processing to a plurality of quality maps including the quality map.

These comprehensive or specific aspects may be achieved by a system, a method, an integrated circuit, a computer program, or a recording medium such as a computer-readable CD-ROM, or may be achieved by any combination of the system, the method, the integrated circuit, the computer program, and the recording medium.

### BRIEF DESCRIPTION OF THE DRAWINGS

FIG. 1 is a diagram illustrating an example of a data analysis system according to an exemplary embodiment.

FIG. 2 is a diagram illustrating a configuration of the data analysis device according to the exemplary embodiment.

FIG. 3 is a diagram illustrating an example of structured data according to the exemplary embodiment.

FIG. 4 is a diagram illustrating an example of image data according to the exemplary embodiment.

FIG. 5 is a block diagram illustrating a functional configuration of the data analysis device according to the exemplary embodiment.

FIG. 6 is a flowchart illustrating processing of the data analysis device according to the exemplary embodiment.

FIG. 7 is an explanatory diagram illustrating an example of a feature map according to the exemplary embodiment.

FIG. 8 is an explanatory diagram illustrating an example of a feature vector obtained from a feature map according to the exemplary embodiment.

FIG. 9 is an explanatory diagram illustrating an example of a connected feature vector according to the exemplary embodiment.

FIG. 10 is an explanatory diagram illustrating an example of a compressed feature vector according to the exemplary embodiment.

FIG. 11 is an explanatory diagram illustrating an example of a feature map corresponding to each component of a compressed feature vector according to the exemplary embodiment.

FIG. 12 is an explanatory diagram illustrating an example of an integrated map according to the exemplary embodiment.

FIG. 13 is an explanatory diagram illustrating an example of a defect heat map according to the exemplary embodiment.

FIG. 14 is an explanatory diagram illustrating an example of an integrated map according to the exemplary embodiment.

FIG. 15 is an explanatory diagram illustrating an example of a first feature according to the exemplary embodiment.

FIG. 16 is an explanatory diagram illustrating an example of a second feature according to the exemplary embodiment.

FIG. 17 is an explanatory diagram illustrating an example of a causal analysis result according to the exemplary embodiment.

### DESCRIPTION OF EMBODIMENT

### Underlying Knowledge on the Present Disclosure

With the progress of the Internet of Things (IoT), the type and amount of data to be handled are increasing.

In the case of analyzing data, a so-called single-modal analysis method, which is a conventional analysis method targeting only one type of data, can be used. However, the data that can be analyzed by the single-modal analysis method is limited, and in a case of analyzing a wide variety of data, it may not be possible to perform analysis by the single-modal analysis method. Therefore, a multi-modal analysis method capable of simultaneously analyzing a plurality of types of data has been devised.

A data analysis device and the like according to the present disclosure generate structured data from unstructured data (for example, image data or time series data) in a multi-modal analysis method. Note that generating structured data from unstructured data may be expressed as structuring unstructured data.

The technique described in NPL 1 extracts a feature vector from unstructured data (specifically, image data) using a pre-trained model and converts the feature vector into structured data. However, in the above technique, if the feature is calculated only by one pre-trained model using various types of image data in a complicated manufacturing process or defect patterns of products, there is a problem that the accuracy of the feature may decrease.

Therefore, the present disclosure provides a data analysis device or the like that provides appropriate information related to quality of a product from unstructured data related to the product.

Hereinafter, an invention obtained from the disclosure of the present specification will be exemplified, and effects and the like obtained from the invention will be described.

(1) A data analysis device including an acquisition unit configured to acquire target data that is unstructured data related to a product and quality information indicating the acceptability of the product, an extraction unit configured to input the target data to each of a plurality of neural network models for analyzing unstructured data, extract a plurality of feature maps calculated by a plurality of intermediate layers included in each of the plurality of neural network models, and generate a quality map indicating the acceptability of the product represented in the unstructured data using the plurality of extracted feature maps, and an integration unit configured to generate an integrated map by applying statistical processing to a plurality of quality maps including the quality map.

According to the above aspect, the data analysis device generates the integrated map in which the plurality of quality maps generated using the plurality of feature maps calculated by the intermediate layers of the plurality of neural network models are integrated. The integrated map generated by the analysis device is map information obtained by integrating a plurality of quality maps, and the plurality of quality maps are map information generated using a plurality of feature maps calculated by an intermediate layer of a plurality of neural network models for target data. Therefore, there is a possibility that the quality of the product is appropriately expressed. Therefore, the data analysis device can provide appropriate information related to the quality of a product from unstructured data related to the product.

(2) The data analysis device according to (1), in which the extraction unit is configured to execute (a) inputting the target data to each of the plurality of neural network models and extracting a plurality of feature maps calculated by a plurality of intermediate layers included in each of the plurality of neural network models, (b) more preferentially acquiring two or more statistical values having a larger correlation with the quality information among a plurality of statistical values including statistical values of a plurality of features included in each of the plurality of extracted feature maps, and (c) generating the quality map by integrating two or more feature maps corresponding to the two or more acquired statistical values among the plurality of feature maps.

According to the above aspect, the data analysis device generates the quality map using the feature map corresponding to the feature having a relatively large correlation with the quality information without using the feature map corresponding to the feature having a relatively small correlation with the quality information among the plurality of feature maps calculated by the plurality of intermediate layers included in the plurality of neural network models. Then, the integration unit generates the integrated map using the quality map generated by the extraction unit as described above. Therefore, in the integrated map generated by the integration unit, the contribution of the feature map corresponding to the feature having a relatively large correlation with the quality information is increased, and the relevance of the information provided by the data analysis device to the quality of the product can be further increased. Therefore, the data analysis device can provide more appropriate information related to the quality of the product from the unstructured data related to the product.

(3) The data analysis device according to (2), in which the extraction unit acquires the statistical value for each of the plurality of feature maps by calculating an average value of a plurality of features included in the feature map, and generates the quality map using the acquired statistical value.

According to the above aspect, the data analysis device can more easily generate the quality map using the average value of the plurality of features included in the feature map as the statistical value. Therefore, the data analysis device can more easily provide appropriate information related to the quality of the product from the unstructured data related to the product.

(4) The data analysis device according to any one of (1) to (3), in which the unstructured data includes image data in which the product is shown.

According to the above aspect, the data analysis device can provide appropriate information related to the quality of the product using the image showing the product as the unstructured data.

(5) The data analysis device according to any one of (1) to (4), in which the plurality of neural network models includes at least a model of SqueezeNet, ConvNeXt, or EfficientNet.

According to the above aspect, the data analysis device can more easily extract a plurality of feature maps by using at least a model of SqueezeNet, ConvNeXt, or EfficientNet as a plurality of neural network models. Therefore, the data analysis device can more easily provide appropriate information related to the quality of the product from the unstructured data related to the product.

(6) A data analysis method including acquiring target data that is unstructured data related to a product and quality information indicating the acceptability of the product, inputting the target data to each of a plurality of neural network models for analyzing unstructured data, extracting a plurality of feature maps calculated by a plurality of intermediate layers included in each of the plurality of neural network models, and generating a quality map indicating the acceptability of the product represented in the unstructured data using the plurality of extracted feature maps, and generating an integrated map by applying statistical processing to a plurality of quality maps including the quality map.

According to the above aspect, the same effects as those of the data analysis device are obtained.

(7) A program for causing a computer to execute the data analysis method according to (6).

According to the above aspect, the same effects as those of the data analysis device are obtained.

These comprehensive or specific aspects may be implemented by a system, a method, an integrated circuit, a computer program, or a recording medium such as a computer-readable CD-ROM, or may be implemented by any combination of the system, the method, the integrated circuit, the computer program, or the recording medium.

Hereinafter, exemplary embodiments will be specifically described with reference to the drawings.

Note that the exemplary embodiments described below illustrate comprehensive or specific examples. Numerical values, shapes, materials, constituent elements, arrangement positions and connection configurations of the constituent elements, steps, processing order of the steps, and the like shown in the following exemplary embodiment are just an example, and are not intended to limit the present disclosure. Those components introduced in the following exemplary embodiments that are not recited in the independent claim(s) representing the most superordinate concept are illustrated herein as optional components.

### Exemplary Embodiment

### Hardware Configuration

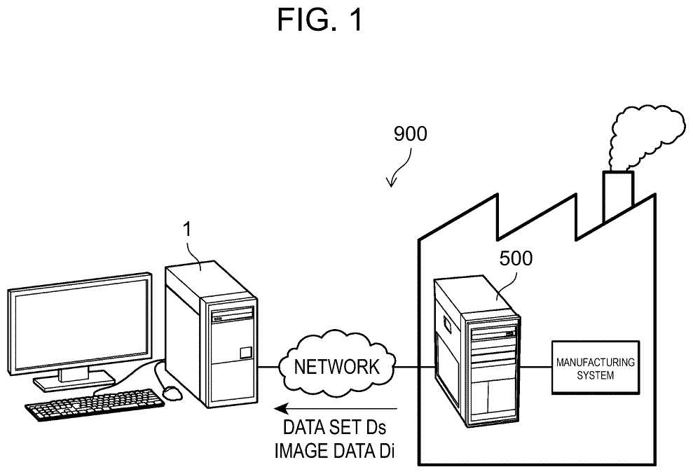

FIG. 1 is a diagram illustrating an example of a data analysis system according to the present exemplary embodiment.

Data analysis system 900 according to the present exemplary embodiment includes data analysis device 1 and manufacturing management device 500.

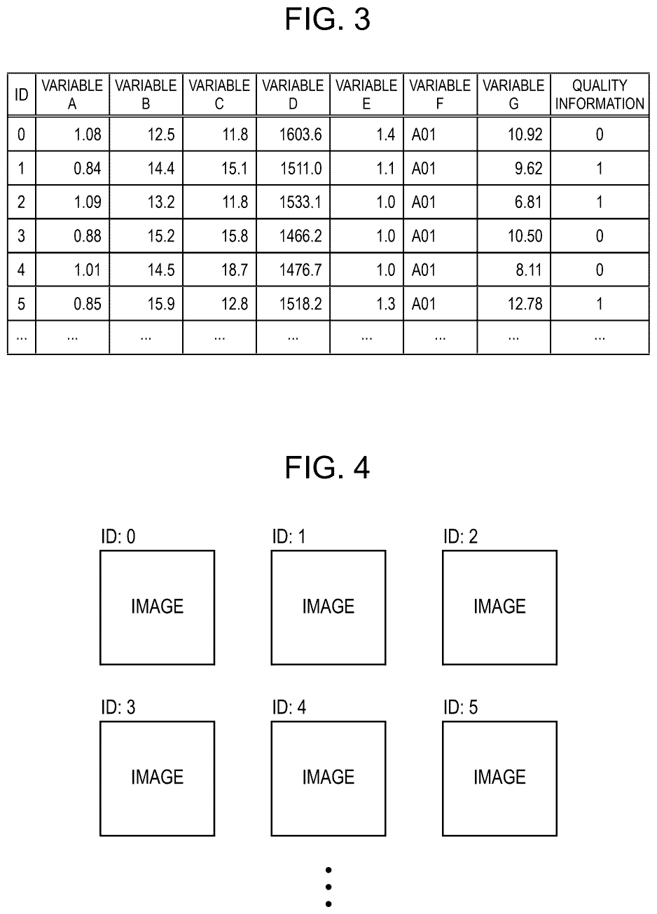

Manufacturing management device 500 is, for example, a device that is installed in a manufacturing factory and manages a manufacturing system for manufacturing a product. Manufacturing management device 500 transmits data set Ds and image data Di obtained by the manufacturing system to data analysis device 1 via a network such as the Internet. Note that data set Ds is an example of structured data, and image data Di is an example of unstructured data. Data set Ds and image data Di will be described later with reference to FIGS. 3 and 4.

Data analysis device 1 includes a personal computer and the like. Data analysis device 1 receives data set Ds and image data Di from above-described manufacturing management device 500. Then, data analysis device 1 performs analysis based on received data set Ds and image data Di, and provides information related to the quality of the product or information having a causal relationship with the quality of the product. The information on the quality of the product is assumed to be managed by, for example, a product manufacturing system, and is assumed to be visually recognized by, for example, a manager of the manufacturing system and used to improve a defect of the product.

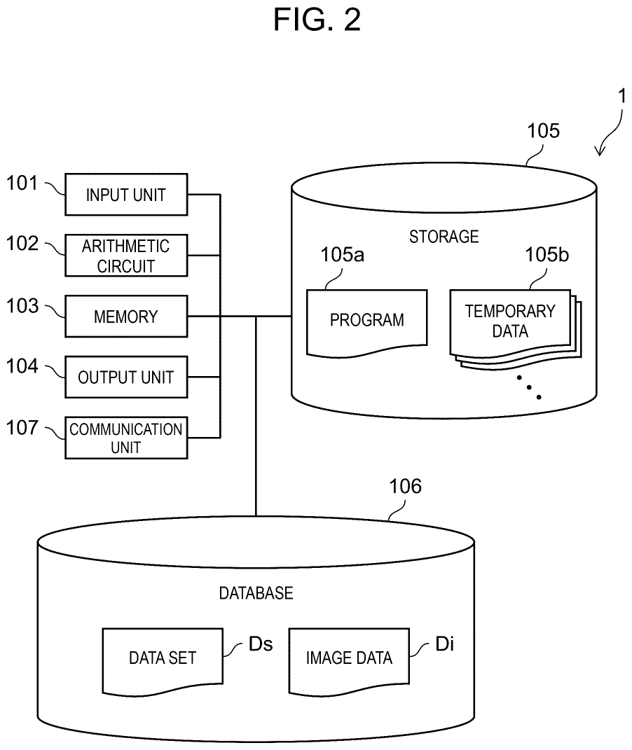

FIG. 2 is a diagram illustrating a configuration of data analysis device 1 according to the present exemplary embodiment.

Data analysis device 1 includes input unit 101, arithmetic circuit 102, memory 103, output unit 104, storage 105, database 106, and communication unit 107.

Communication unit 107 communicates with a device outside data analysis device 1. This communication may be wired communication or wireless communication. The wireless communication method may be Wi-Fi (registered trademark), Bluetooth (registered trademark), or ZigBee (registered trademark), or may be other methods. For example, communication unit 107 communicates with manufacturing management device 500 and receives data set Ds and image data Di from manufacturing management device 500.

Input unit 101 has a function as a human machine interface (HMI) that receives an input operation by a user, and includes, for example, a keyboard, a mouse, a touch sensor, a touch pad, and the like.

Output unit 104 includes a display that displays an image, characters, or the like. The display is, for example, a liquid crystal display, a plasma display, an organic electro-luminescence (EL) display, or the like. Note that, output unit 104 may include a printer that prints an image, characters, or the like, and may have a function of storing data output from arithmetic circuit 102 in storage 105 in a file format.

Storage 105 stores program (that is, computer program) 105a in which each command to arithmetic circuit 102 is described. In addition, each temporary data 105b temporarily generated by processing of arithmetic circuit 102 may be stored in storage 105. Storage 105 also stores a machine learning model used for analysis of image data Di.

Note that, such storage 105 is a non-volatile recording medium, and is, for example, a magnetic storage device such as a hard disk, an optical disk, a semiconductor memory, or the like. Note that, program 105a is provided to data analysis device 1 via, for example, a removable medium or a network, and is stored in storage 105. The removable medium is, for example, a compact disc read only memory (CD-ROM), a flash memory, or the like. Thus, communication unit 107 may include an interface that reads program 105a of the removable medium.

Program 105a read and loaded by arithmetic circuit 102 is temporarily stored in memory 103. Such memory 103 is, for example, a volatile random access memory (RAM).

Arithmetic circuit 102 is a circuit that executes program 105a loaded in memory 103, and is, for example, a central processing unit (CPU), a graphics processing unit (GPU), or the like. Arithmetic circuit 102 may use each temporary data 105b stored in storage 105 when program 105a is executed.

Similarly to storage 105, database 106 is a non-volatile recording medium, and is, for example, a magnetic storage device such as a hard disk, an optical disk, a semiconductor memory, or the like. For example, arithmetic circuit 102 acquires data set Ds and image data Di from manufacturing management device 500 via the network and communication unit 107, and stores data set Ds and image data Di in database 106.

Note that, in the present exemplary embodiment, an example in which storage 105 and database 106 are different recording media is described, but storage 105 and database 106 may be constituted as one recording medium including the storage and the database.

### Data Set

FIG. 3 is a diagram illustrating data set Ds which is an example of structured data in the present exemplary embodiment.

Data set Ds illustrated in FIG. 3 is a raw data set transmitted from manufacturing management device 500, and includes structured data. Data set Ds can include, for example, a plurality of pieces of data indicating setting values indicating physical properties or conditions in a manufacturing process of the above-described manufacturing system, sensor values acquired by measurement in the manufacturing process, quality of a product produced by the manufacturing process, and the like.

Specifically, data set Ds includes variable names of a plurality of variables A, B, C, D, E, F, and G in the production and data of those variables for each identifier (ID) that is an identifier indicating the production order. The plurality of variables A to G indicate, for example, force, voltage, current, temperature, irradiation time, dimension, or the like.

In addition, data set Ds includes the quality information of the product obtained by the production for each identifier. The quality information is information indicating a result of the quality determination of the product, and indicates whether each product is a non-defective product or a defective product. For example, in the quality information, “1” indicates that the product is a non-defective product, and “0” indicates that the product is a defective product.

As the ID of the product, the ID of the production from which the product is obtained can be used. That is, the product whose ID is n means a product obtained by production whose ID is n.

Note that, the data may be any data as long as the data indicates at least one of a character and a number. In addition, variable names of a plurality of variables may be arranged in the first row of data set Ds. Data of each of the plurality of variables is arranged in each corresponding one of the second and subsequent rows of data set Ds.

An inspection image is associated with each production ID. The inspection image associated with the production ID may be an image obtained by photographing the product of the ID obtained by the production with a camera or the like.

FIG. 4 is a diagram illustrating an example of image data Di according to the present exemplary embodiment.

FIG. 4 illustrates an example of images in which products whose IDs are 0, 1, 2, 3, 4, and 5 are photographed as an example of image data Di. The images illustrated in FIG. 4 may be external appearance images of the product captured by cameras or the like at the time of quality inspection of the product. The quality inspection of the product is performed by, for example, an operator or an inspection facility.

### Configuration of Data Analysis Device

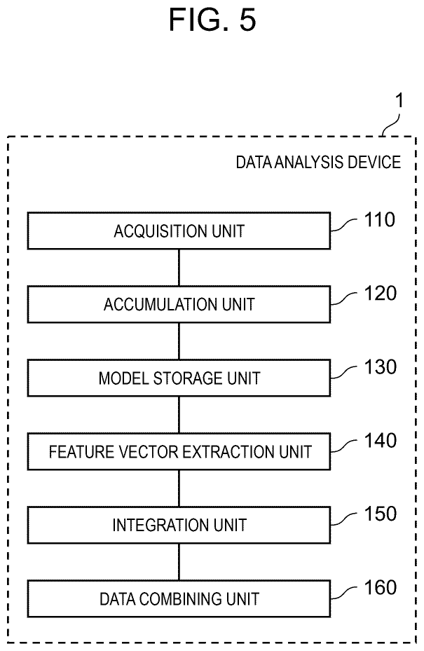

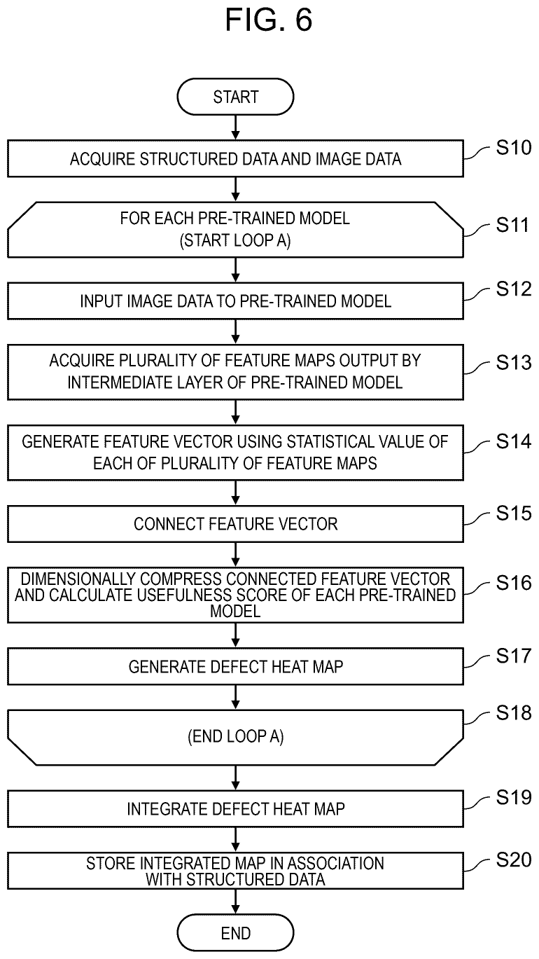

A configuration of data analysis device 1 according to the present exemplary embodiment will be described with reference to FIG. 5 and FIG. 6.

FIG. 5 is a block diagram illustrating a functional configuration of data analysis device 1 according to the present exemplary embodiment.

As illustrated in FIG. 5, data analysis device 1 includes acquisition unit 110, accumulation unit 120, model storage unit 130, feature vector extraction unit 140, integration unit 150, and data combining unit 160.

Acquisition unit 110 acquires production performance data. Acquisition unit 110 acquires data set Ds (see FIG. 3), which is an example of structured data related to a product, as production performance data, and acquires image data Di (see FIG. 4), which is an example of unstructured data. Data set Ds includes, for example, a setting value indicating physical properties or conditions in the manufacturing process, a sensor value acquired by measurement in the manufacturing process, and quality information indicating a quality inspection result of the produced product. The unstructured data acquired by acquisition unit 110 is also referred to as target data.

Acquisition unit 110 can acquire the sensor value included in the structured data and the setting value of the facility as explanatory variables. In addition, acquisition unit 110 can acquire the quality information included in the structured data as an objective variable.

Acquisition unit 110 can acquire the data using communication unit 107.

Accumulation unit 120 stores the data acquired by acquisition unit 110 (that is, structured data and unstructured data). Accumulation unit 120 can store the data acquired by acquisition unit 110 in database 106.

Model storage unit 130 stores a plurality of pre-trained models. Each of the plurality of pre-trained models is a learned model that is a neural network model trained using a large-scale data set (for example, Image-Net image data set). The neural network model is a neural network model for analyzing unstructured data. The plurality of pre-trained models stored in model storage unit 130 may be selected using prediction accuracy or the like as an evaluation index. The plurality of pre-trained models stored in model storage unit 130 is used for feature vector extraction unit 140 to analyze unstructured data. Among the plurality of pre-trained models stored in model storage unit 130, the number of pre-trained models used by feature vector extraction unit 140 may be adjusted depending on the type of unstructured data. Model storage unit 130 can store the pre-trained model in storage 105.

The neural network model that is the pre-trained model stored in model storage unit 130 may include at least a model of SqueezeNet, ConvNeXt, or EfficientNet.

feature vector extraction unit 140 inputs target data to each of the plurality of pre-trained models stored in model storage unit 130, and extracts a plurality of feature maps calculated by a plurality of intermediate layers (also referred to as target layers) included in each of the plurality of pre-trained models. Then, feature vector extraction unit 140 generates a quality map using the plurality of extracted feature maps. The quality map is a map indicating the acceptability of the product expressed in the target data acquired by acquisition unit 110. Feature vector extraction unit 140 is also simply referred to as an extraction unit.

More specifically, feature vector extraction unit 140 inputs target data to each of the plurality of pre-trained models, and extracts a plurality of feature maps calculated by a plurality of target layers included in each of the plurality of pre-trained models. In addition, feature vector extraction unit 140 preferentially acquires two or more statistical values having a higher correlation with the quality information among the plurality of statistical values including the statistical values of the plurality of features included in each of the plurality of extracted feature maps. Then, feature vector extraction unit 140 generates a quality map by integrating two or more feature maps corresponding to the acquired two or more statistical values among the plurality of feature maps.

Feature vector extraction unit 140 inputs unstructured data (corresponding to target data) stored in accumulation unit 120 to each of the plurality of pre-trained models stored in model storage unit 130, thereby extracting a plurality of feature maps calculated by a plurality of target layers included in each of the plurality of pre-trained models. In addition, feature vector extraction unit 140 calculates a statistical value of each of the plurality of extracted feature maps as a feature. Feature vector extraction unit 140 can acquire the statistical value of each of the plurality of feature maps by calculating the average value of the plurality of features included in the feature map, and generate the quality map using the acquired statistical value.

Feature vector extraction unit 140 acquires a plurality of features including the feature of each of the plurality of feature maps. Feature vector extraction unit 140 can handle a plurality of features acquired in this manner collectively as a vector (also referred to as a feature vector).

Feature vector extraction unit 140 acquires one feature vector for each of the plurality of feature maps. Feature vector extraction unit 140 acquires, for one pre-trained model, the same number of feature vectors as the number of target layers included in the pre-trained model. Therefore, feature vector extraction unit 140 acquires the same number of feature vectors as the total number of the plurality of target layers for each pre-trained model by inputting the target data to the plurality of pre-trained models.

Furthermore, feature vector extraction unit 140 obtains one feature vector (also referred to as a connected feature vector) by connecting a plurality of feature vectors acquired from the pre-trained model for each pre-trained model. Therefore, feature vector extraction unit 140 obtains the same number of connected feature vectors as the number of the plurality of pre-trained models.

Next, feature vector extraction unit 140 acquires a dimensionally compressed feature vector (also referred to as a compressed feature vector) by executing dimensional compression processing on each connected feature vector. The dimensional compression processing is processing of obtaining a feature vector (corresponding to a compressed feature vector) having a smaller number of dimensions by more preferentially extracting a predetermined number of components having a larger correlation with the quality information of the product among the respective components of the connected feature vector as a target. The dimensional compression processing is performed by, for example, a method such as Elastic-Net analysis using the objective variable (that is, the quality information) stored in accumulation unit 120, and this case will be described as an example. In addition, feature vector extraction unit 140 calculates the usefulness score for each pre-trained model using the Elastic-Net model created at the time of the dimensional compression processing. The usefulness score is an index indicating whether the pre-trained model can appropriately predict the quality information with respect to the target data.

Then, feature vector extraction unit 140 generates a quality map by integrating the feature maps corresponding to the components of the compressed feature vector. The quality map is map information indicating a position where the quality is expressed in image data as target data.

Integration unit 150 calculates one feature map (also referred to as an integrated map) by integrating a plurality of quality maps using the usefulness scores of the respective pre-trained models calculated by feature vector extraction unit 140. The process of integrating the plurality of quality maps includes, for example, a process of calculating a weighted average value of the quality maps using the usefulness score for each pre-trained model as a weight. The weight may be set to 1, for example, if the usefulness score is greater than a predetermined threshold, and set to 0 if the usefulness score is less than the predetermined threshold.

Data combining unit 160 stores the integrated map calculated by integration unit 150 in accumulation unit 120 in association with the structured data. The integrated map stored by data combining unit 160 can correspond to information related to the quality of the product or information having a causal relationship with the quality of the product provided by data analysis device 1.

### Example of Data Analysis Method

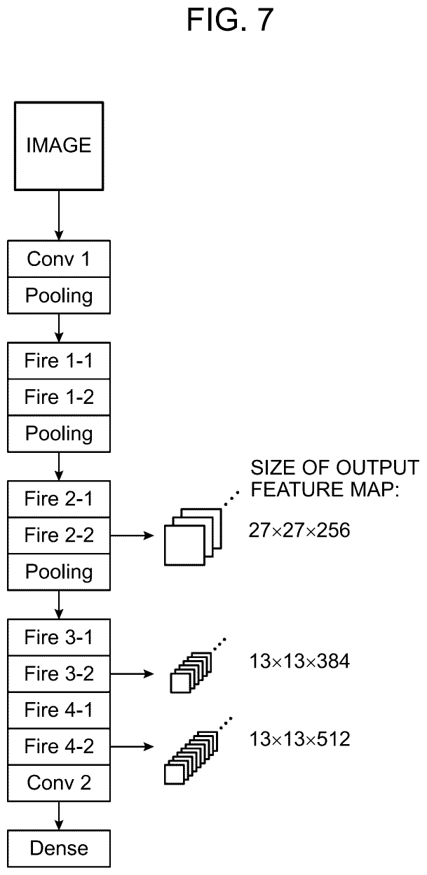

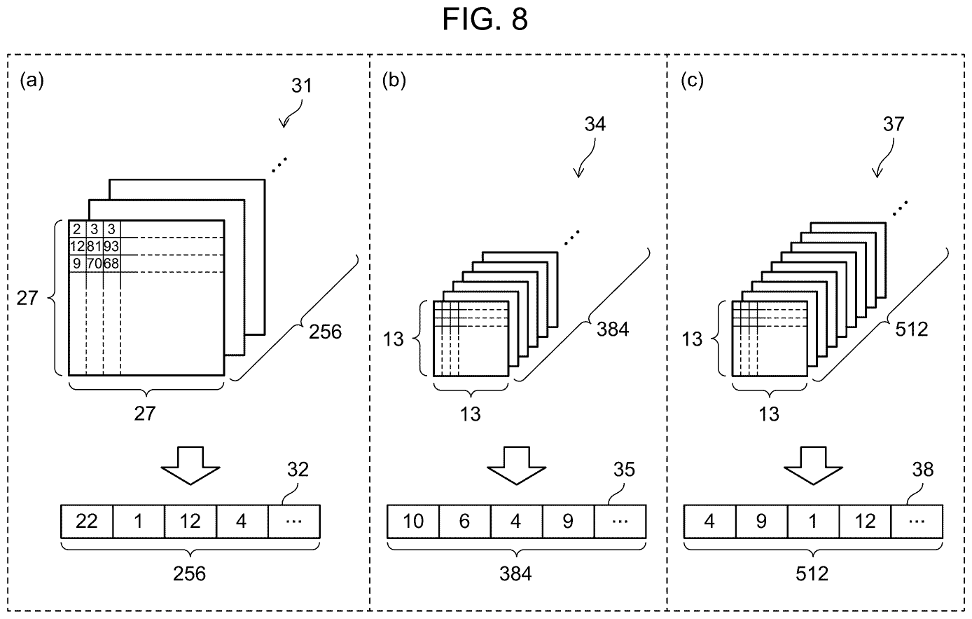

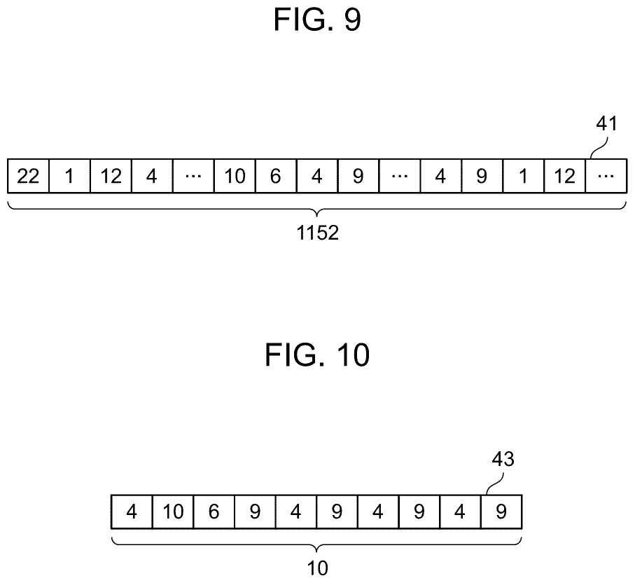

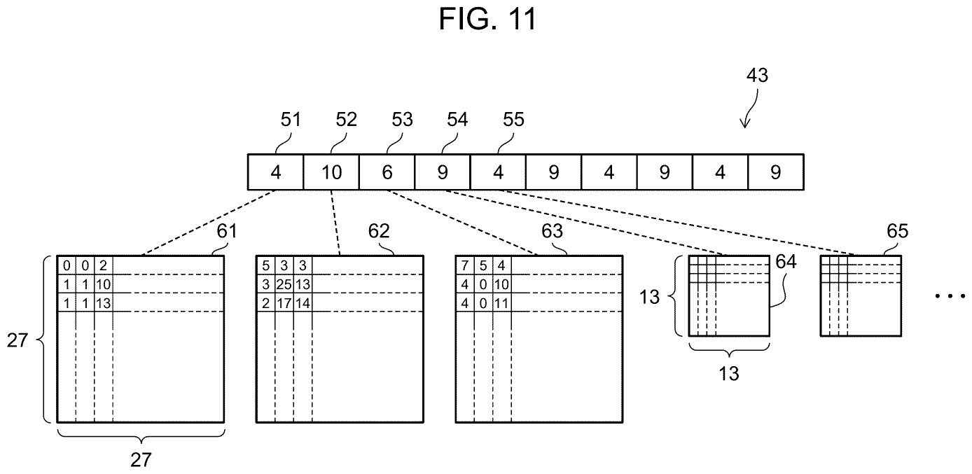

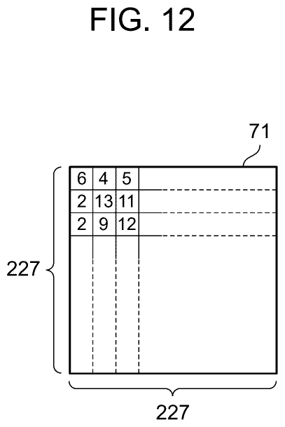

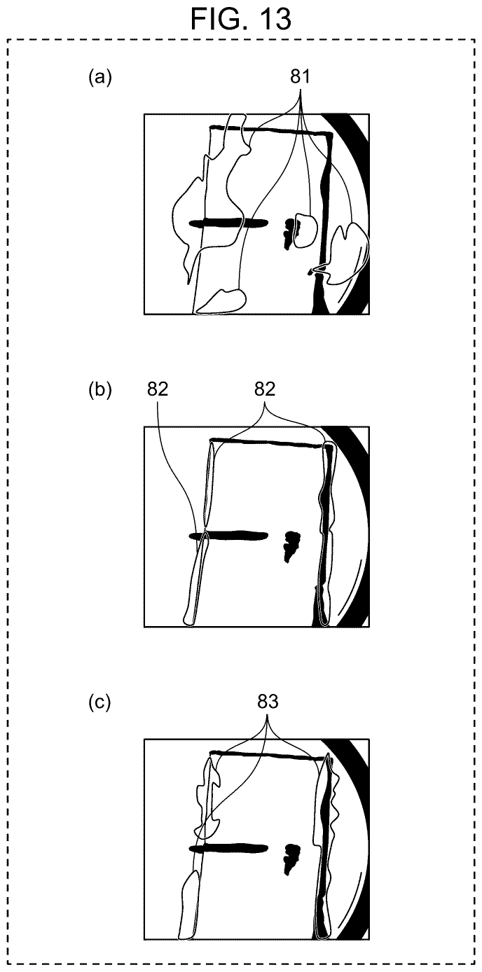

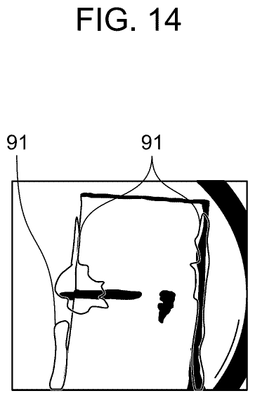

FIG. 6 is a flowchart illustrating processing of data analysis device 1 according to the exemplary embodiment. FIG. 7 is an explanatory diagram illustrating an example of a feature map in the present exemplary embodiment. FIG. 8 is an explanatory diagram illustrating an example of a feature vector obtained from a feature map in the present exemplary embodiment. FIG. 9 is an explanatory diagram illustrating an example of connected feature vectors according to the present exemplary embodiment. FIG. 10 is an explanatory diagram illustrating an example of a compressed feature vector in the present exemplary embodiment. FIG. 11 is an explanatory diagram illustrating an example of a feature map corresponding to each component of a compressed feature vector in the present exemplary embodiment. FIG. 12 is an explanatory diagram illustrating an example of an integrated map in the present exemplary embodiment. FIG. 13 is an explanatory diagram illustrating an example of a defect heat map in the present exemplary embodiment. FIG. 14 is an explanatory diagram illustrating an example of an integrated map in the present exemplary embodiment.

The processing of data analysis device 1 will be described with reference to FIGS. 6 to 14.

In step S10, acquisition unit 110 acquires production performance data (see FIG. 3) as structured data and image data (see FIG. 4) as unstructured data, and stores the acquired production performance data and image data in accumulation unit 120. Accumulation unit 120 temporarily stores the production performance data and the image data. The image data acquired by acquisition unit 110 is also referred to as input image data (or simply an input image).

In step S11, feature vector extraction unit 140 performs start processing of loop A for repeatedly performing the processing in steps S12 to S17 described later. In loop A, focusing on each of the plurality of pre-trained models stored in model storage unit 130, processing using the focused pre-trained model is executed, and finally processing using all of the plurality of pre-trained models is performed. Note that the pre-trained model of interest is also referred to as a pre-trained model of interest. Note that the processing in steps S12 to S17 using each pre-trained model included in loop A may be performed sequentially or simultaneously in parallel.

In model storage unit 130, for example, three pre-trained models of SqueezeNet, ConvNeXt, and EfficientNet, which are pre-trained models trained using the Image-Net image data set, are stored. Note that the three pre-trained models can be selected by using the abnormality detection accuracy and the size of the pre-trained model (in other words, the number of parameters) when the MVTec Anomaly Detection Dataset (MVTec AD) is used as an evaluation data set as evaluation indices. The high abnormality detection accuracy indicates that the performance of the pre-trained model is good. In addition, the small size of the pre-trained model indicates that the weight reduction level of the pre-trained model is high, which contributes to shortening of the necessary time for processing.

In step S12, feature vector extraction unit 140 inputs image data to the pre-trained model of interest.

In step S13, feature vector extraction unit 140 acquires information (also referred to as a feature map) output from the intermediate layer (corresponding to the target layer) of each of the pre-trained models of interest by inputting the image data to the pre-trained model of interest in step S12.

With reference to FIG. 7, the structure of SqueezeNet, which is an example of the pre-trained model, and the feature map output by the intermediate layer will be described.

The SqueezeNet includes a Conv layer, a Pooling layer, a Fire layer, and a Dense layer. Here, a case where feature vector extraction unit 140 acquires the feature maps output by the Fire 2-2, the Fire 3-2, and the Fire 4-2 of the Fire layers, which are the intermediate layers, will be described as an example.

The image input to the SqueezeNet is an RGB image with a resolution of 227×227. The sizes of the plurality of feature maps output by the Fire 2-2 that is the intermediate layer are 27×27×256. That is, the Fire 2-2 outputs 256 feature maps including 27 values in the vertical direction and 27 values in the horizontal direction.

Similarly, the sizes of the plurality of feature maps output by the Fire 3-2 and the Fire 4-2 are 13×13×384 and 13×13×512, respectively.

In step S14, feature vector extraction unit 140 generates a feature vector using the statistical value of each of the plurality of feature maps. The generation of the feature vector will be described with reference to FIG. 8.

FIG. 8 illustrates processing of generating a feature vector using a plurality of feature maps.

The plurality of feature maps 31 illustrated in (a) of FIG. 8 are 256 feature maps output by the Fire 2-2.

Feature vector 32 illustrated in (a) of FIG. 8 is a vector having a statistical value of a plurality of features included in each of the 256 feature maps output by the Fire 2-2 (see FIG. 7) as a component, in other words, a 256-dimensional vector. The statistical value of the feature included in the feature map is, for example, an average value of the features included in the feature map. The same applies to the following.

The plurality of feature maps 34 illustrated in (b) of FIG. 8 are 384 feature maps output by the Fire 3-2 (see FIG. 7). The feature vector 35 illustrated in (b) of FIG. 8 is a vector having a statistical value of a plurality of features included in each of the 384 feature maps output by the Fire 3-2 as a component, in other words, a 384-dimensional vector.

The plurality of feature maps 37 illustrated in (c) of FIG. 8 are 512 feature maps output by the Fire 4-2 (see FIG. 7). The feature vector 38 illustrated in (c) of FIG. 8 is a vector having a statistical value of a plurality of features included in each of the 512 feature maps output by the Fire 4-2 as a component, in other words, a 512-dimensional vector.

In step S15, feature vector extraction unit 140 generates a new feature vector (corresponding to the connected feature vector) by connecting the plurality of feature vectors generated in step S14. For example, feature vector extraction unit 140 generates 1152-dimensional connected feature vector 41 by connecting 256-dimensional feature vector 32, a 384-dimensional feature vector 35, and a 512-dimensional feature vector 38 illustrated in FIG. 8 (see FIG. 9).

In step S16, feature vector extraction unit 140 dimensionally compresses the connected feature vector generated in step S15 and outputs the usefulness score of each pre-trained model.

Specifically, feature vector extraction unit 140 extracts a specific feature among features that are components of the connected feature vectors generated in step S15, and generates a new feature vector (also referred to as a compressed feature vector) having the extracted specific feature as a component. The specific feature extracted by feature vector extraction unit 140 may be a feature having a relatively high correlation with the quality inspection result of the product. As an example, feature vector extraction unit 140 can extract a feature having a relatively high correlation with the quality inspection result of the product by using the Elastic-Net analysis method using the quality information for the connected feature vector. In this manner, feature vector extraction unit 140 generates a feature vector including a feature having a relatively high correlation with the quality information.

For example, feature vector extraction unit 140 extracts 10 features having a relatively high correlation with the quality inspection result of the product among 1152 features included in the connected feature vector, and generates 10-dimensional compressed feature vector 43 having the extracted features as components (see FIG. 10).

Furthermore, feature vector extraction unit 140 calculates a usefulness score indicating whether the pre-trained model can appropriately predict the quality information for the target data.

In step S17, feature vector extraction unit 140 uses the compressed feature vector generated in step S16 to generate a new feature map obtained by integrating a plurality of feature maps. The new feature map corresponds to a quality map indicating the acceptability of a product expressed in image data. Here, a case will be described as an example in which a defect heat map indicating at which position in an image a defective portion of a product appears is used as the new feature map. A method for generating a defect heat map using a compressed feature vector will be described with reference to FIG. 11.

When a plurality of features which are components included in compressed feature vector 43 are calculated, feature vector extraction unit 140 specifies a plurality of feature maps which are the basis of the calculation. Then, feature vector extraction unit 140 adjusts the size of each of the plurality of specified feature maps while interpolating pixels so as to match the size (that is, 227×227) of the input image data.

The feature maps on which the features 51, 52, 53, 54, and 55, which are components of compressed feature vector 43 illustrated in FIG. 11, are calculated are feature maps 61, 62, 63, 64, and 65, respectively. Specifically, feature vector extraction unit 140 adjusts the sizes of the feature maps 61, 62, and 63 having a size of 27×27 to 227×227, and adjusts the sizes of the feature maps 64 and 65 having a size of 13×13 to 227×227.

The interpolation of the pixels can be performed by, for example, bilinear interpolation. Then, feature vector extraction unit 140 can generate defect heat map 71 by adding the values located at the same position included in the interpolated feature maps (see FIG. 12). The size of defect heat map 71 is 227×227 which is the same as the size of the input image. Defect heat map 71 indicates a position where a defective portion of a product is represented in the input image.

The defect heat map will be further described with reference to FIG. 13.

For example, (a) of FIG. 13 illustrates an image in which the defect heat map generated by feature vector extraction unit 140 is superimposed on the input image. In the image illustrated in (a) of FIG. 13, it is indicated that a defective portion exists in region 81.

In step S18, feature vector extraction unit 140 performs end processing of loop A. Specifically, feature vector extraction unit 140 determines whether the processing in steps S12 to S17 has been executed focusing on each of the plurality of pre-trained models, and performs control such that the processing is performed focusing on a pre-trained model that has not been performed yet in a case where the processing has not been performed.

By the processing of loop A, feature vector extraction unit 140 acquires the same number (that is, three) of compressed feature vectors as the pre-trained model and acquires the same number (that is, three) of usefulness scores as the pre-trained models and the defect heat maps for one piece of image data. Three images each on which a defect heat map is superimposed are illustrated in (a), (b), and (c) of FIG. 13. The images illustrated in (b) and (c) of FIG. 13 each illustrate that there is a defective portion in the regions 82 and 83, respectively.

In step S19, integration unit 150 generates a new defect heat map (also referred to as an integrated map) by integrating the defect heat maps generated in step S17. First, integration unit 150 determines whether to adopt three defect heat maps generated for one piece of image data as a defect heat map to be integrated (also referred to as a target defect heat map) based on the usefulness score. For example, integration unit 150 can determine to adopt a defect heat map having a usefulness score higher than a threshold as the target defect heat map, and determine not to adopt another defect heat map as the target defect heat map. Then, integration unit 150 obtains an integrated map by averaging a plurality of defect heat maps determined to be adopted as the target defect heat map. The averaging of the plurality of defect heat maps is performed by calculating an average of values located at the same position included in the plurality of defect heat maps.

FIG. 14 illustrates an image in which the integrated map is superimposed on the input image. Region 91 in the image illustrated in FIG. 14 indicates a region where a defect exists.

In step S20, data combining unit 160 stores the coordinates, area, or shape of the defective portion indicated in the defect heat map adopted as the defect heat map to be integrated in step S19 in accumulation unit 120 in association with the production performance data (in other words, the existing structured data).

Through the series of processes illustrated in FIG. 6, data analysis device 1 can provide appropriate information (specifically, the integrated map in which the target defect heat map is integrated) related to the quality of a product from unstructured data related to the product.

### Analysis Example

Hereinafter, an example of analyzing the cause of the defect by performing causal analysis using the above data will be described.

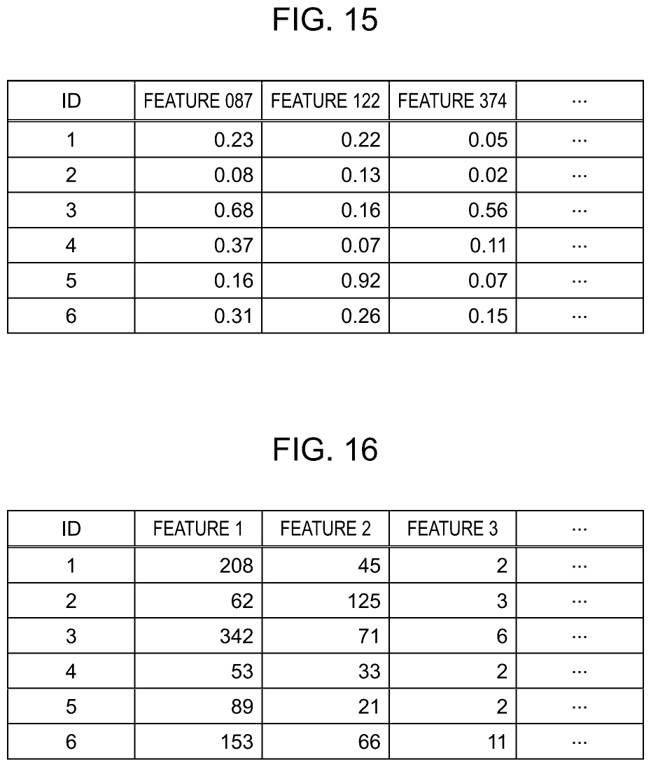

FIG. 15 is an explanatory diagram illustrating an example of the first feature according to the present exemplary embodiment.

FIG. 15 illustrates an example of the first features for six products whose IDs are 1 to 6. The first feature is each component of the compressed feature vector calculated by data analysis device 1 based on the input image in which the product is illustrated. Feature 087, feature 122, and feature 374, which are the first features illustrated in FIG. 15, can correspond to the 87th, 122nd, and 374th features of the 1152-dimensional connected feature vector, respectively.

Since at least inference processing based on a pre-trained model is used for calculating the first feature, the first feature is a feature having a relatively large correlation with the quality of each product, but it is not clear what specific physical amount or parameter the first feature corresponds to.

FIG. 16 is an explanatory diagram illustrating an example of a second feature according to the present exemplary embodiment. The second feature is a feature indicating coordinates, an area, and coordinates of a region indicating a defective portion in the defect heat map. The second feature has a feature that it corresponds to a specific physical amount or parameter such as coordinates of a region indicating a defective portion while the first feature has a feature that it is not clear what specific physical amount or parameter the first feature corresponds to.

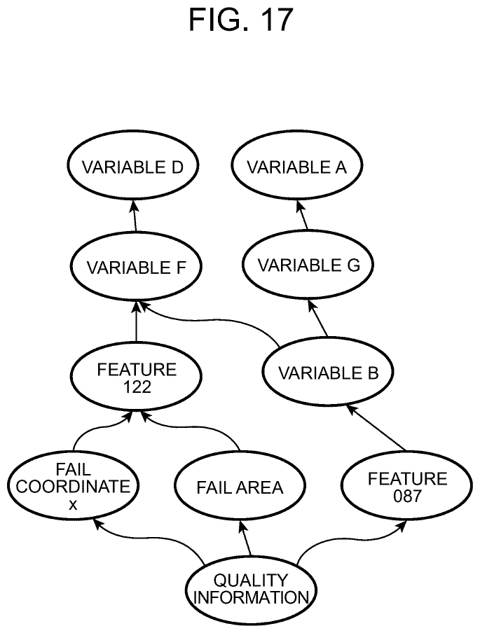

FIG. 17 is an explanatory diagram illustrating an example of a causal analysis result in the present exemplary embodiment.

FIG. 17 illustrates, as a causal graph, a result of performing causal analysis on production performance data (see FIG. 3), a first feature (see FIG. 15), and a second feature (see FIG. 16), which are structured data, using a linear non-Gaussian acyclic model (LiNGAM) causal search method. In FIG. 17, the tip (end point) of the arrow indicates the cause, and the root (start point) of the arrow indicates the result.

In the causal graph illustrated in FIG. 17, for example, it is indicated that the cause of the “quality information” is “fail coordinate x”, the “fail area”, and “feature 087”, the cause of “fail coordinate x” is “feature 122”, the cause of “feature 122” is “variable F”, and the cause of “variable F” is “variable D”. “Feature 122” and “feature 087” are the first features, for example, feature 122 and feature 087 illustrated in FIG. 15. In addition, “fail coordinate x” and the “fail area” are the second features, and are, for example, any of the features illustrated in FIG. 16.

With reference to FIG. 17, it is understood that the factors affecting the “quality information” are “variable D” and “variable A”.

The fact that the causal graph illustrated in FIG. 17 is obtained is proof that the feature calculated by data analysis device 1 is appropriate, and furthermore, proof that the data analysis method executed by data analysis device 1 is appropriate.

In the above exemplary embodiment, each constituent element may be implemented by dedicated hardware, or implemented by executing a software program suitable for each component. Each constituent element may be implemented by a program executor such as a CPU or a processor reading and executing a software program recorded in a recording medium such as a hard disk or a semiconductor memory. Here, software for implementing the data analysis device and the like of the above exemplary embodiments is a program as described below.

That is, this program is a program for causing a computer to execute a data analysis method including: acquiring target data that is unstructured data related to a product and quality information indicating the acceptability of the product; inputting the target data to each of a plurality of neural network models for analyzing the unstructured data; extracting a plurality of feature maps calculated by a plurality of intermediate layers included in each of the plurality of neural network models; generating a quality map indicating the acceptability of the product represented in the unstructured data using the plurality of extracted feature maps; and generating an integrated map by applying statistical processing to a plurality of quality maps including the quality map generated by inputting the target data to each of the plurality of neural network models.

Although the data analysis device and the like according to one or more aspects have been described above based on the exemplary embodiments, the present disclosure is not limited to exemplary embodiments. Configurations in which various modifications conceivable by those skilled in the art are applied to the present exemplary embodiment and configurations constructed by combining components in different exemplary embodiments may also be included in the scope of one or more aspects without departing from the gist of the present disclosure.

The data analysis device of the present disclosure can provide appropriate information related to the quality of a product from unstructured data related to the product.

### Industrial Applicability

The present disclosure is applicable to a device that analyzes the quality of a product.

### Reference Marks in the Drawings

1 data analysis device
31, 34, 37, 61, 62, 63, 64, 65 feature map
32, 35, 38 feature vector
41 connected feature vector
43 compressed feature vector
51, 52, 53, 54, 55 feature
71 defect heat map
81, 82, 83, 91 region
101 input unit
102 arithmetic circuit
103 memory
104 output unit
105 storage
105a program
105b temporary data
106 database
107 communication unit
110 acquisition unit
120 accumulation unit
130 model storage unit
140 feature vector extraction unit
150 integration unit
160 data combining unit
500 manufacturing management device
900 data analysis system
Ds data set
Di image data

1. A data analysis device comprising:
an acquisition unit configured to acquire target data that is unstructured data related to a product and quality information indicating the acceptability of the product;
an extraction unit configured to input the target data to each of a plurality of neural network models for analyzing unstructured data, extract a plurality of feature maps calculated by a plurality of intermediate layers included in each of the plurality of neural network models, and generate a quality map indicating the acceptability of the product represented in the unstructured data using the plurality of extracted feature maps; and
an integration unit configured to generate an integrated map by applying statistical processing to a plurality of quality maps including the quality map.

2. The data analysis device according to claim 1, wherein
the extraction unit is configured to execute:
(a) inputting the target data to each of the plurality of neural network models and extracting a plurality of feature maps calculated by a plurality of intermediate layers included in each of the plurality of neural network models;
(b) more preferentially acquiring two or more statistical values having a larger correlation with the quality information among a plurality of statistical values including statistical values of a plurality of features included in each of the plurality of extracted feature maps; and
(c) generating the quality map by integrating two or more feature maps corresponding to the two or more acquired statistical values among the plurality of feature maps.

3. The data analysis device according to claim 2, wherein
the extraction unit acquires the statistical value for each of the plurality of feature maps by calculating an average value of a plurality of features included in the feature map, and generates the quality map using the acquired statistical value.

4. The data analysis device according to claim 1, wherein
the unstructured data includes image data in which the product is shown.

5. The data analysis device according to claim 1, wherein
the plurality of neural network models includes at least a model of SqueezeNet, ConvNeXt, or EfficientNet.

6. A data analysis method comprising:
acquiring target data that is unstructured data related to a product and quality information indicating the acceptability of the product;
inputting the target data to each of a plurality of neural network models for analyzing unstructured data, extracting a plurality of feature maps calculated by a plurality of intermediate layers included in each of the plurality of neural network models, and generating a quality map indicating the acceptability of the product represented in the unstructured data using the plurality of extracted feature maps; and
generating an integrated map by applying statistical processing to a plurality of quality maps including the quality map.

7. A program for causing a computer to execute the data analysis method according to claim 6.
